(19) United States
(12) Patent Application Publication
(10) Pub. No.: US 2022/0351869 A1
(43) Pub. Date: Nov. 3, 2022

(54) SYSTEMS AND METHODS FOR GENERATING HEAT FROM REACTIONS BETWEEN HYDROGEN ISOTOPES AND METAL CATALYSTS

(71) Applicants: Dennis J. CRAVENS, Cloudcroft, NM (US); Dennis G. LETTS, Austin, TX (US); Robert J. HIGGINS, Cloudcroft, NM (US); IH IP Holdings Limited, St. Helier (JE)

(72) Inventors: Dennis J. Cravens, Cloudcroft, NM (US); Dennis G. Letts, Austin, TX (US); Robert J. Higgins, Cloudcroft, NM (US)

(21) Appl. No.: 16/498,095

(22) PCT Filed: Sep. 25, 2019
(86) PCT No.: PCT/US2019/052923

§ 371 Date: Sep. 26, 2019

Related U.S. Application Data
(60) Provisional application No. 62/893,479, filed on Aug. 29, 2019.

(51) Int. Cl. G21B 3/00

(52) U.S. Cl. CPC G21B 3/004

(57) ABSTRACT

A method for generating heat reactions between hydrogen isotopes and a metal catalyst includes placing at least one fuel source within a reactor. The reactor includes an anode and a cathode, wherein the cathode is a metallic vessel, wherein the at least one fuel source comprises a metal substrate thermally sprayed with a metal catalyst, and wherein the at least one fuel source is in thermal and electrical contact with the reactor. The method includes sealing the reactor to produce a vacuum within the reactor. The method includes adding hydrogen to the reactor and adding deuterium to the reactor. The method includes supplying a current to the reactor from a DC power supply.

### CROSS-REFERENCE TO RELATED APPLICATIONS

This application claims priority to U.S. Provisional Patent Application No. 62/893,479 filed on Aug. 29, 2019, the entire content of which is hereby incorporated by reference.

### BACKGROUND

Many metals and their alloys are known to take up hydrogen in its various isotopic forms and mixtures; some metal-hydrogen systems are classified as exothermic absorbers and produce a small amount of chemical heat when loaded with hydrogen. Often, hydrogen in its various isotopic forms as pure isotopes, mixtures, or naturally abundant hydrogen are loaded into hydrogen absorbing metals with the intent of evolving usable heat or other physical events. Methods of triggering the metal-hydrogen reaction have been developed using radio frequency stimulation, laser stimulation, or magnetic field stimulation to generate and investigate physical responses. All of these methods require external agents to act on the hydrogen isotopes contained within the absorbing catalyst or attached to its surface.

Externally applied triggering methods are known to work in evolving modest amounts of heat from catalysts by absorbing hydrogen or by catalysts formed from metal hydrides and their alloys. Two of the currently known external triggering methods are limited in the extent to which they are able to couple with the contained hydrogen and its isotopes. Radio frequency energy cannot penetrate into the metal or hydride beyond a few microns; lasers operate at a much higher frequency, making their penetration depth much less than radio frequency stimulation. Heat evolution is thought to be directly related to the amount of hydrogen that can be stimulated by an external triggering method.

### SUMMARY OF THE INVENTION

The term “hydrogen” as used herein refers to hydrogen in all its isotopic forms including hydrogen, deuterium, tritium, or mixtures thereof unless specified otherwise.

This disclosure provides a system and method for evolving larger amounts of usable heat from a metal-hydrogen system that has been loaded with hydrogen and deuterium in a predetermined specified range of isotopic ratios and over a range of predetermined specified pressures.

Specifically, the present invention discloses a system and method for providing for internal triggering of hydrogen that evolves usable heat from a catalyst capable of absorbing hydrogen. This system and method obviates the need for external stimulation and has the potential to couple the stimulation to a much larger amount of hydrogen fuel contained in the catalyst than externally applied triggering methods.

In one embodiment of the present invention, a system for generating heat reactions between hydrogen isotopes and a metal catalyst may include a reactor. The reactor may include an anode and a cathode, wherein the cathode is a metallic vessel. The system may further include at least one fuel source disposed within the reactor, wherein the at least one fuel source may include a metal substrate thermally sprayed with a metal catalyst, and wherein the at least one fuel source is in thermal and electrical contact with the reactor. The system may further include a hydrogen source configured to add hydrogen to the reactor after the reactor is sealed, and a deuterium source configured to add deuterium to the reactor after the reactor is sealed. The system may further include a DC power supply configured to supply a current to the reactor.

In another embodiment of the present invention, a method for generating heat reactions between hydrogen isotopes and a metal catalyst may include placing at least one fuel source within a reactor. The reactor may include an anode and a cathode, wherein the cathode is a metallic vessel, wherein the at least one fuel source comprises a metal substrate thermally sprayed with a metal catalyst, and wherein the at least one fuel source is in thermal and electrical contact with the reactor. The method may further include sealing the reactor to produce a vacuum within the reactor. The method may further include adding hydrogen to the reactor and adding deuterium to the reactor. The method may further include supplying a current to the reactor from a DC power supply.

In yet another embodiment of the present invention, a method for generating heat reactions between hydrogen isotopes and a metal catalyst may further include reducing pressure in the reactor, adding hydrogen to the reactor, and adding deuterium to the reactor. The method may further include detecting a change in heat evolution. The method may further include repeating the reducing pressure, adding hydrogen, and adding deuterium steps until a change in heat evolution is detected.

In yet another embodiment of the present invention, the anode may be a metallic rod.

In yet another embodiment of the present invention, the metallic rod may be comprised of one of molybdenum and tungsten.

In yet another embodiment of the present invention, the metallic vessel may be comprised of stainless steel.

In yet another embodiment of the present invention, the at least one fuel source may be configured to slidably fit into the reactor.

In yet another embodiment of the present invention, the at least one fuel source may be hemicylindrical.

In yet another embodiment of the present invention, the metal catalyst may be a hydrogen-absorbing metal.

In yet another embodiment of the present invention, the metal catalyst may be comprised of a nickel and aluminum alloy.

In yet another embodiment of the present invention, the metal substrate may be titanium.

In yet another embodiment of the present invention, sealing the reactor may produce a vacuum of at least 1×10⁻⁴ torr in the reactor.

In yet another embodiment of the present invention, the hydrogen source and deuterium source may be configured to add enough hydrogen and deuterium to produce at least 20 torr pressure in the reactor.

In yet another embodiment of the present invention, the DC power supply may be configured to supply at least 200 mA of current to the reactor.

In yet another embodiment of the present invention, the DC power supply may be configured to supply current in pulsed cycles.

### BRIEF DESCRIPTION OF THE DRAWINGS

FIG. 1 is a system diagram of a system for generating heat reactions between hydrogen isotopes and a metal catalyst may include a reactor according to an embodiment of the present invention.

FIG. 2 is a flow diagram of a method for generating heat reactions between hydrogen isotopes and a metal catalyst may include a reactor according to an embodiment of the present invention.

FIG. 3 is a flow diagram of a method for generating heat reactions between hydrogen isotopes and a metal catalyst may include a reactor according to an embodiment of the present invention.

FIG. 4 is an illustration of thermally spraying a metal catalyst onto a metal substrate according to an embodiment of the present invention.

FIG. 5 is a graph depicting the heat evolution of reactions between hydrogen isotopes and a metal catalyst may include a reactor according to an embodiment of the present invention.

FIG. 6 is a graph depicting the isoperibolic method of detecting heat evolution according to an embodiment of the present invention.

### DETAILED DESCRIPTION

In the following description, for the purposes of explanation, numerous specific details are set forth in order to provide a thorough understanding of the embodiments of the invention. One skilled in the art will recognize that the embodiments of the invention may be practiced without these specific details or with an equivalent arrangement. In other instances, well-known structures and devices are shown in block diagram form in order to avoid unnecessarily obscuring the embodiments of the invention.

The presently disclosed subject matter is presented with sufficient details to provide an understanding of one or more particular embodiments of broader inventive subject matters. The descriptions expound upon and exemplify particular features of those particular embodiments without limiting the inventive subject matters to the explicitly described embodiments and features. Considerations in view of these descriptions will likely give rise to additional and similar embodiments and features without departing from the scope of the presently disclosed subject matter.

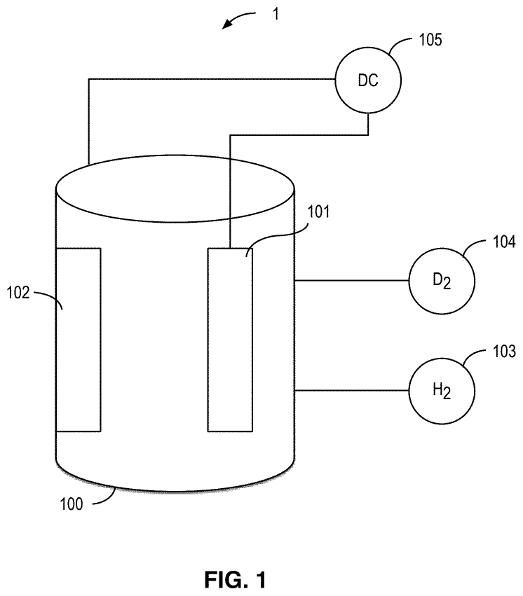

Referring now to FIG. 1, in one embodiment of the present invention, a system 1 for generating heat reactions between hydrogen isotopes and a metal catalyst may comprise a reactor 10. The reactor 10 may comprise an anode 101 and a cathode 100, wherein the cathode 100 is a metallic vessel. The system 1 may further comprise at least one fuel source 102 disposed within the reactor 10, wherein the at least one fuel source 102 may include a metal substrate thermally sprayed with a metal catalyst, and wherein the at least one fuel source 102 is in thermal and electrical contact with the reactor 10. The system 1 may further comprise a hydrogen source 103 configured to add hydrogen to the reactor 10 after the reactor 10 is sealed, and a deuterium source 104 configured to add deuterium to the reactor 10 after the reactor 10 is sealed. The system 1 may further comprise a DC power supply 105 configured to supply a current to the reactor 10.

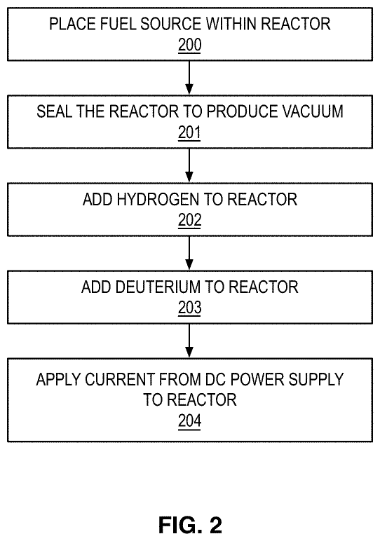

Referring now to FIG. 2, in another embodiment of the present invention, a method for generating heat reactions between hydrogen isotopes and a metal catalyst may comprise placing at least one fuel source within a reactor 200. The reactor may include an anode and a cathode, wherein the cathode is a metallic vessel, wherein the at least one fuel source comprises a metal substrate thermally sprayed with a metal catalyst, and wherein the at least one fuel source is in thermal and electrical contact with the reactor. The method may further comprise sealing the reactor to produce a vacuum within the reactor 201. The method may further comprise adding hydrogen to the reactor 202 and adding deuterium to the reactor 203. The method may further comprise supplying a current to the reactor form a DC power supply 204.

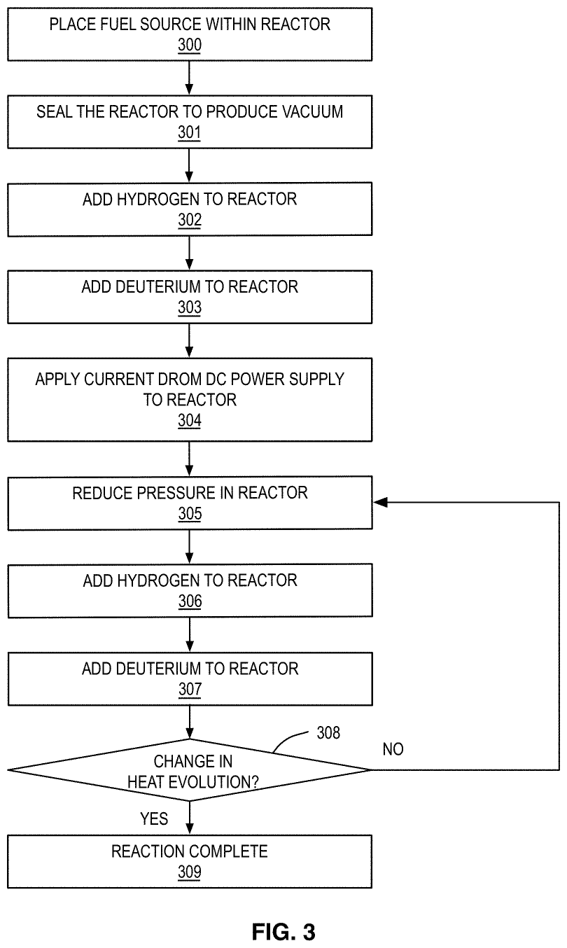

Referring now to FIG. 3, in another embodiment of the present invention, a method for generating heat reactions between hydrogen isotopes and a metal catalyst may further comprise reducing pressure in the reactor 305, adding hydrogen to the reactor 306, and adding deuterium to the reactor 307. The method may further include detecting a change in heat evolution 308. The method may further include repeating the reducing pressure 305, adding hydrogen 306, and adding deuterium 307 steps until a change in heat evolution is detected.

The systems and methods of this disclosure begin with thermal spraying a hydrogen-absorbing catalyst onto a metal substrate. In one embodiment chosen to illustrate the present invention, the catalyst was 95% nickel and 5% aluminum. The geometry of the substrate may be arbitrary and will depend upon the shape and size of the thermal reactor used. In the configuration discussed here, the reactor is a tubular stainless-steel vessel serving as the cathode (negative DC) and a slender metallic rod serving as the anode (positive DC). The anode can be any rugged metal, such as molybdenum or tungsten.

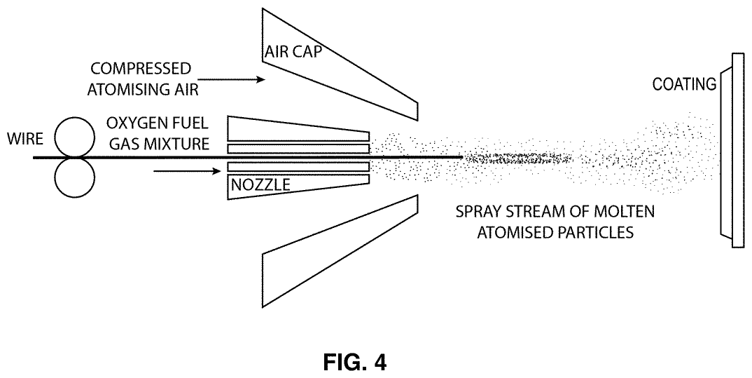

At least one fuel source within the reactor may be comprised of a metal substrate thermally sprayed with a metal catalyst. For example, in one embodiment, the metal substrate may be a tube open on both ends is selected so it will enter the tubular reactor with a sliding fit to maintain thermal and electrical contact with the surrounding reactor. The tube may be cut longitudinally into two equal sections as shown in FIG. 1 such that they are hemicylindrical. Before inserting into the tubular reactor, the two hemicylindrical sections (fuel sleeves) are thermally sprayed with a known hydrogen absorbing metal as depicted in FIG. 4. Thermal spraying is commonly known and available commercially—for example, at Midwest Thermal Spray of Farmington Hills, Mich.

Thermal spraying has several attractive features such as producing a robust and adherent catalyst over a metal substrate, such as titanium. Thermally-sprayed surfaces are also coarse and the coarseness of the surface can be controlled by various parameters inherent to the thermal spray process. The material used to spray onto the substrates discussed here is in powder form and can be an alloyed powder of many known metals. The powder can also be a mixture or a combination of powders with various sizes. Metal wires can also be used as feed stock, as shown in FIG. 4.

After the fuel sources are placed in the reactor, it may be sealed to produce a vacuum of at least 1×10⁻⁴ torr. The hydrogen source and deuterium source may be configured to add enough hydrogen and deuterium to produce at least 20 torr pressure in the reactor. For example, naturally abundant hydrogen may be added to the reactor to a pressure of 15 torr; then the flow of naturally abundant hydrogen may be stopped and deuterium may be added to the reactor up to a pressure of 20 torr. Then a DC power supply may be turned on to at least 200 mA of current to ignite a glow discharge, forming a plasma.

While the discharge is running at 200 mA, the reactor pressure may be reduced to about 0.5 to about 1 torr, sufficient pressure to maintain the glow discharge. This low pressure may be held for at least 5 minutes, then hydrogen may be added to produce about 1 to about 15 torr such that it comprises a predominance of mass. Deuterium may be added to produce a pressure up to about 20 torr. This process is repeated several times until heat evolution changes.

Although flame spraying is the preferred embodiment, it should be readily apparent that other methods of adhering the active material to the sleeve to be put in the tube or to affix to the tube itself can be utilized. Such methods include electroplating, burnishing, materials selected for the inserts and other methods.

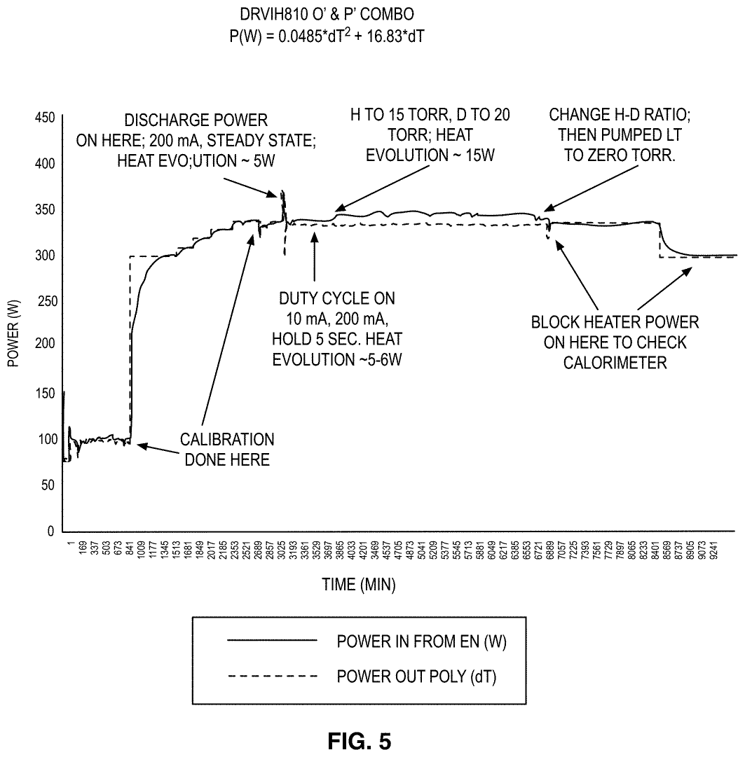

In yet another embodiment, the DC power supply may be configured to provide current at a predetermined pulse rate. In one embodiment chosen to illustrate the present invention, a KEPCO power supply was set at 10 mA for 5 seconds, then at 200 mA for 5 seconds and repeated through similar cycles. This method is thought to improve loading and to provide a flux of hydrogen across the metal-gas interface, which enhances heat evolution from the catalyst. This method typically triggers a larger thermal signal than steady-state operation as shown in FIG. 5. The cycling between high and low plasma currents appears in this embodiment to increase the ability of the metal to take up hydrogen. Although an Ni alloy was used in the embodiment discussed here, metals such as Ti and Pd and its alloys are envisioned and are under investigation; it is envisioned that any hydrogen absorbing metals with significant hydrogen diffusion rates can be used, such as those with a permeability rate above 0.05 cm³/cm²/sec at the expected working temperature. Preferably, cycles have a duration between about 0.01 seconds and 10 minutes to produce significant heat about that of equivalent steady state high voltage applications.

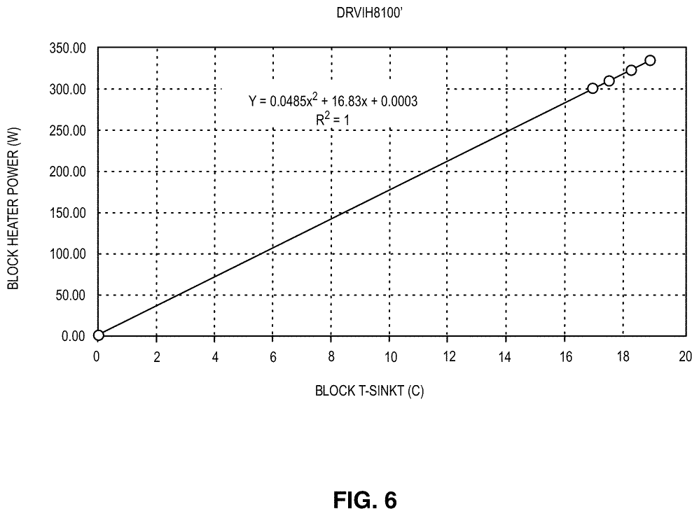

Heat evolution can be detected and quantified using several methods: the isoperibolic method, the Seebeck method, and the mass flow method. For this disclosure, heat evolution was measured by a carefully calibrated isoperibolic method FIG. 6.

The heat evolution measured for this disclosure is shown in FIG. 5. The test began by powering the reactor at 100 watts with power applied to resistance heaters only, embedded in a copper block surrounding the reactor. Then the discharge was turned on at a steady 200 mA and the resistance heater power was reduced under computer control to keep total power at 100 W. Over the range of 400 minutes to 900 minutes the reactor was in thermal equilibrium when powered by resistance heaters or by the discharge. The dT was approximately 5.98C in all cases. Then power to the block heaters was advanced to 300 watts and then to 340 watts in steps of 10 W. A thermal balance was achieved in all cases. Then the system was set to 335 watts of resistance heater power at the 2900-minute marker. At the 3100-minute marker, discharge power was turned on to 200 mA in steady state with heat evolution in the 5-watt range. This low thermal evolution persisted even in duty cycle or pulse mode until minute-marker 3760 when the hydrogen to deuterium ratio was set to 15:5 torr. At that instant, heat evolution increased from 5 watts to 15 watts and held until the hydrogen-deuterium gas ratio was intentionally changed and the pressure reduced to around 1 torr. At that point, heat evolution declined to baseline and the calorimeter showed zero heat evolution above that provided by the electrical input as illustrated in FIG. 5.

The above description and drawings are illustrative and are not to be construed as limiting the invention to the precise forms disclosed. Persons skilled in the relevant art can appreciate that many modifications and variations are possible in light of the above disclosure. Numerous specific details are described to provide a thorough understanding of the disclosure. However, in certain instances, well-known or conventional details are not described in order to avoid obscuring the description.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof, means any connection or coupling, either direct or indirect, between two or more elements; the coupling of connection between the elements can be physical, logical, or any combination thereof. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The teachings of the disclosure provided herein can be applied to other systems, not necessarily the system described above. The elements and acts of the various embodiments described above can be combined to provide further embodiments.

These and other changes can be made to the disclosure in light of the above Detailed Description. While the above description describes certain embodiments of the disclosure, and describes the best mode contemplated, no matter how detailed the above appears in text, the teachings can be practiced in many ways. Details of the system may vary considerably in its implementation details, while still being encompassed by the subject matter disclosed herein. As noted above, particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to limit the disclosure to the specific embodiments disclosed in the specification, unless the above Detailed Description section explicitly defines such terms. Accordingly, the actual scope of the disclosure encompasses not only the disclosed embodiments, but also all equivalent ways of practicing or implementing the disclosure under the claims.

The terms used in this specification generally have their ordinary meanings in the art, within the context of the disclosure, and in the specific context where each term is used. Certain terms that are used to describe the disclosure are discussed above, or elsewhere in the specification, to provide additional guidance to the practitioner regarding the description of the disclosure. For convenience, certain terms may be highlighted, for example using capitalization, italics and/or quotation marks. The use of highlighting has no influence on the scope and meaning of a term; the scope and meaning of a term is the same, in the same context, whether or not it is highlighted. It will be appreciated that same element can be described in more than one way.

Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any exemplified term. Likewise, the disclosure is not limited to various embodiments given in this specification.

Without intent to further limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions will control.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

Unless defined otherwise, all technical and scientific terms used herein have the same meaning as commonly understood to one of ordinary skill in the art to which the presently disclosed subject matter pertains. Although any methods, devices, and materials similar or equivalent to those described herein can be used in the practice or testing of the presently disclosed subject matter, representative methods, devices, and materials are now described.

Following long-standing patent law convention, the terms “a”, “an”, and “the” refer to “one or more” when used in the subject specification, including the claims. Thus, for example reference to “an additive” can include a plurality of such additives, and so forth.

Unless otherwise indicated, all numbers expressing quantities of components, conditions, and so forth used in the specification and claims are to be understood as being modified in all instances by the term “about”. Accordingly, unless indicated to the contrary, the numerical parameters set forth in the instant specification and attached claims are approximations that can vary depending upon the desired properties sought to be obtained by the presently disclosed subject matter.

As used herein, the term “about”, when referring to a value or to an amount of mass, weight, time, volume, concentration, and/or percentage can encompass variations of, in some embodiments+/−20%, in some embodiments, +/−10%, in some embodiments+/−5%, in some embodiments+/−1%, in some embodiments+/−0.5%, and in some embodiments, +/−0.1%, from the specified amount, as such variations are appropriate in the disclosed products and methods.

1. A system for generating heat from reactions between hydrogen isotopes and a metal catalyst comprising:
a reactor comprising:
an anode; and
a cathode, wherein the cathode is a metallic vessel;
at least one fuel source disposed within the reactor,
wherein the at least one fuel source comprises a metal substrate thermally sprayed with a metal catalyst, and
wherein the at least one fuel source is in thermal and electrical contact with the reactor; and
a hydrogen source configured to add hydrogen to the reactor after the reactor is sealed;
a deuterium source configured to add deuterium to the reactor after the reactor is sealed; and
a DC power supply configured to supply a current to the reactor.

2. The system of claim 1, wherein the anode is metallic rod.

3. The system of claim 2, wherein the metallic rod is comprised of one of molybdenum and tungsten.

4. The system of claim 1, wherein the metallic vessel is comprised of stainless steel.

5. The system of claim 1, wherein the at least one fuel source is configured to slidably fit into the reactor.

6. The system of claim 5, wherein the at least one fuel source is hemicylindrical.

7. The system of claim 1, wherein the metal catalyst is a hydrogen-absorbing metal.

8. The system of claim 7, wherein the metal catalyst is comprised of a nickel and aluminum alloy.

9. The system of claim 1, wherein the metal substrate is titanium.

10. The system of claim 1, wherein sealing the reactor produces a vacuum of at least 1×10⁻⁴ torr in the reactor.

11. The system of claim 1, wherein the hydrogen source and deuterium source are configured to add enough hydrogen and deuterium to produce at least 20 torr pressure in the reactor.

12. The system of claim 1, wherein the DC power supply is configured to supply at least 200 mA of current to the reactor.

13. The system of claim 1, wherein the DC power supply is configured to supply current in pulsed cycles.

14. A method of generating heat from reactions between hydrogen isotopes and a metal catalyst comprising:
placing at least one fuel source within a reactor,
wherein the reactor comprises:
an anode; and
a cathode, wherein the cathode is a metallic vessel;
wherein the at least one fuel source comprises a metal substrate thermally sprayed with a metal catalyst, and
wherein the at least one fuel source is in thermal and electrical contact with the reactor;
sealing the reactor to produce a vacuum within the reactor;
adding hydrogen to the reactor;
adding deuterium to the reactor; and
supplying a current to the reactor from a DC power supply.

15. The method of claim 14, wherein the anode is metallic rod.

16. The method of claim 15, wherein the metallic rod is comprised of one of molybdenum and tungsten.

17. The method of claim 14, wherein the metallic vessel is comprised of stainless steel.

18. The method of claim 14, wherein the at least one fuel source is configured to slidably fit into the reactor.

19. The method of claim 18, wherein the at least one fuel source is hemicylindrical.

20. The method of claim 14, wherein the metal catalyst is a hydrogen-absorbing metal.

21. The method of claim 20, wherein the metal catalyst is comprised of a nickel and aluminum alloy.

22. The method of claim 14, wherein the metal substrate is titanium.

23. The method of claim 14, wherein sealing the reactor produces a vacuum of at least 1×10⁴ torr in the reactor.

24. The method of claim 14, wherein adding hydrogen and deuterium includes adding hydrogen and deuterium sufficient to produce at least 20 torr pressure in the reactor.

25. The method of claim 14, wherein supplying current includes supplying at least 200 mA of current to the reactor.

26. The method of claim 14, wherein supplying current includes supplying current in pulsed cycles.

27. The method of claim 14, further comprising:
detecting a change in heat evolution in the reactor; and
if no change is detected:
reducing pressure in the reactor;
adding hydrogen to the reactor; and
adding deuterium to the reactor.
